(19) United States
(12) Patent Application Publication
(10) Pub. No.: US 2016/0066033 A1
(43) Pub. Date: Mar. 3, 2016

(54) SET-TOP BOX

(71) Applicant: HON HAI PRECISION INDUSTRY CO., LTD., New Taipei (TW)

(72) Inventor: PO-JUI LIN, New Taipei (TW)

(21) Appl. No.: 14/699,516

(22) Filed: Apr. 29, 2015

(30) Foreign Application Priority Data
Sep. 3, 2014 (CN) 201410444508.0

(51) Int. Cl. H04N 21/443

(52) U.S. Cl. CPC H04N 21/4432; H04N 21/4436

(57) ABSTRACT

A set-top box includes a casing defining a receiving space. An infrared signal receiver and a power button are received in the receiving space. The casing further defines a mounting hole coupled with the receiving space. An operation button is slidably received in the mounting hole. The infrared signal receiver and the power button face the operation button, infrared signals can pass through the operation button and then be received by the infrared signal receiver.

### FIELD

The subject matter generally relates to a set-top box of a display device.

### BACKGROUND

Set-top boxes are information appliance devices which can turn an external source of signal into content in a form that can then be displayed on a television or other display devices. Typically, a set-top box includes a power button to power on and/or power off the set-top box when being operated. The set-top box further includes a remote signal receiver to receive a remote signal from a remote control.

### BRIEF DESCRIPTION OF THE DRAWINGS

Implementations of the present technology will now be described, by way of example only, with reference to the attached figures.

FIG. 1 is an isometric view of an embodiment of a set-top box.

FIG. 2 is an isometric view of the operation button of FIG. 1.

FIG. 3 is a section view of the set-top box from the direction of II of FIG. 1.

FIG. 4 is an exploded, isometric view of the set-top box of FIG. 1.

FIG. 5 is similar to FIG. 3, but showing the set-top box from another angle.

FIG. 6 is an enlarged view of a operation button, a power button, and an infrared signal receiver included in the set-top box of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series and the like. The term “coupled” is defined as connected, whether directly or indirectly through intervening components, and is not necessarily limited to physical connections. The connection can be such that the objects are permanently connected or releasably connected.

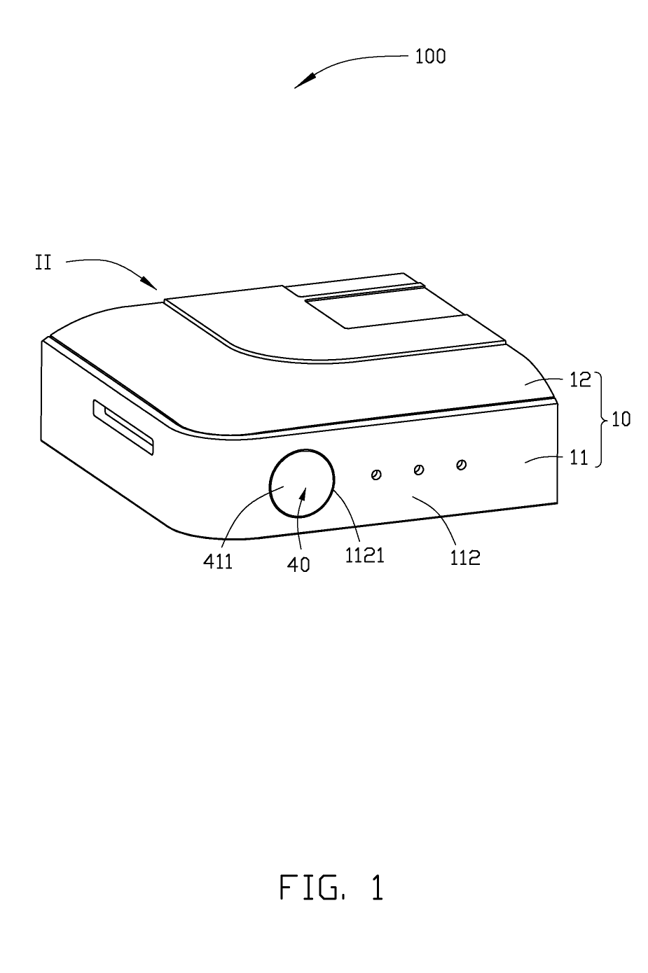

FIG. 1 illustrates an embodiment of a set-top box 100. The set-top box 100 includes a casing 10. The cassing 10 includes a bottom cover 11 and a top cover 12 engaged with the bottom cover 11. The bottom cover 11 includes a bottom portion 111 and four sidewalls 112 surrounding the bottom portion 111. The casing 10 further defines a mounting hole 1121 defined in one of the four sidewalls 112.

The set-top box 100 further includes an operation button 40 slidably received in the mounting hole 1121. The operation button 40 includes an operation surface 411 exposed out of the set-top box 100 to allow pressing by an external force. When the operation surface 411 is pressed, the operation button 40 slides along the mounting hole 1121.

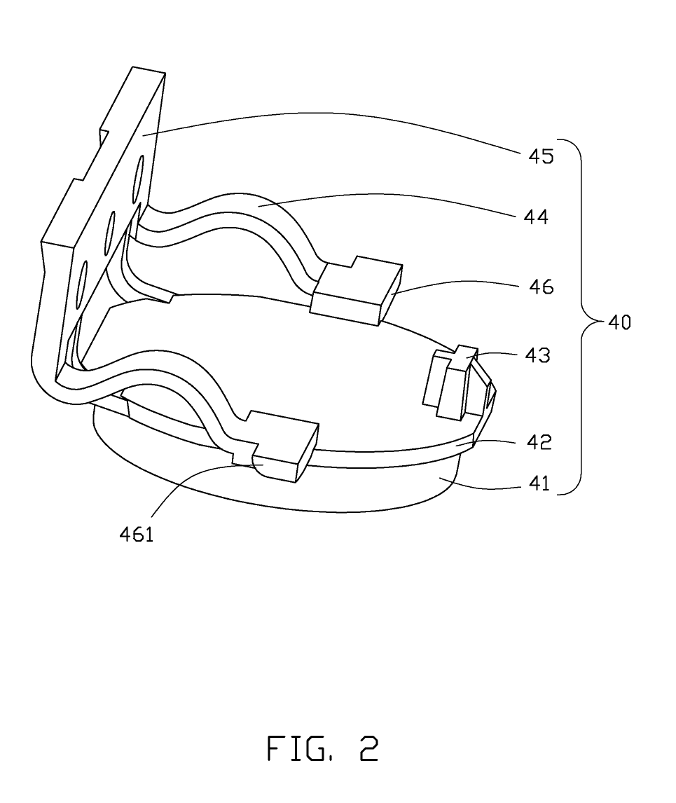

FIG. 2 illustrates the operation button 40 includes a pressing block 41 slidably received in the mounting hole 1121, and at least one elastic arm 44 coupled to the pressing block 41. The operation surface 411 (shown in FIG. 1) is one surface of the pressing block 41. The elastic arm 44 is arranged at the surface of pressing block 41 opposite to the operation surface 411. In at least one embodiment, the operation button 40 includes two pairs of elastic arms 44. One pair of elastic arms 44 is longer than the other pair of elastic arms 44. One end of each pair of elastic arms 44 is coupled to the pressing block 41, and the other end of each pair of elastic arms 44 is coupled to the casing 10. When the operation surface 411 is pressed, the end of each pair of elastic arms 44 coupled to the pressing block 41 moves with the pressing block 41, to cause each pair of elastic arms 44 to be elastically deformed. When the operation surface 411 is released, the pairs of elastic arms 44 rebound to push the pressing block 41 to move until the pressing block 41 back to the starting position. The pressing block 41 is made of material which admits infrared signals to pass through.

The operation button 40 further includes a connecting plate 42 connected to one surface of the pressing block 41. The connecting plate 42 is opposite to the operation surface 411 (shown in FIG. 1), and the connecting plate 42 is slightly wider than the pressing block 41 and the mounting hole 1121, thus preventing the operation button 40 from sliding out of the casing 10. In at least one embodiment, one end of each pair of elastic arms 44 is coupled to the connecting plate 42. When the operation surface 411 is pressed, the connecting plate 42 moves with the pressing block 41 until the connecting plate 42 contacts the sidewall 112. The connecting plate 42 is made of material which admits infrared signals to pass through.

The operation button 40 further includes a protrusion 43 connected to the connecting plate 42 and used to power on or power off the set-top box 100. In at least one embodiment, the protrusion 43 is located adjacent to an edge of the connecting plate 42, the protrusion 43 and pressing block 41 are located at two opposite surfaces of the connecting plate 42. When the operation button 40 is pressed, the protrusion 43 moves with the connecting plate 42.

The operation button 40 further includes a fixing plate 45 coupled to the bottom cover 11 by fastening elements. One end of each pair of elastic arms 44 is secured to the fixing plate 45, thus coupled to the casing 10.

The operation button 40 further includes two supporting blocks 46 located on two opposite edges of the connecting plate 42. An imaginary line connecting the two supporting blocks 46 passes through a center of the connecting plate 42. In at least one embodiment, one end of the longer pair of elastic arms 44 is coupled to the supporting block 46, and the other end of the longer pair of elastic arms 44 is secured on the fixing plate 45. Each supporting block 46 includes a supporting portion 461 extending from the edge of the supporting portion 46.

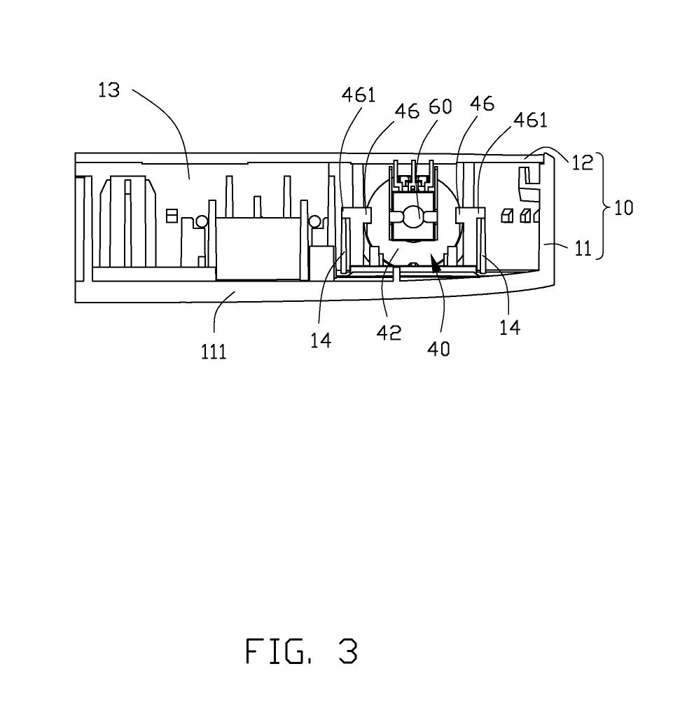

FIG. 3 illustrates the bottom cover 11 and top cover 12 cooperatively form a receiving space 13. The connecting plate 42, the protrusion 43, the elastic arm 44, the fixing plate 45, and the supporting portion 46 are all received in the receiving space 13. The mounting hole 1121 couples to the receiving space 13.

The set-top box 100 further includes two supporting plates 14 received in the receiving space 13. The two supporting plates 14 located on the bottom cover 11 and adjacent to the mounting hole 1121. Each supporting block 461 abuts against the supporting plate 14. When the operation button 40 is pressed, the supporting block 461 slides along the supporting plate 14, thus stress balancing the connecting plate 42, and further limiting the position of the operation button 40.

The bottom cover 11 includes a bottom portion 111. The fixing plate 45 is coupled to the bottom portion 111 by fastening elements.

The set-top box 100 further includes a mounting block 60 received in the receiving space 13 and faces the mounting hole 1121 and the connecting plate 42.

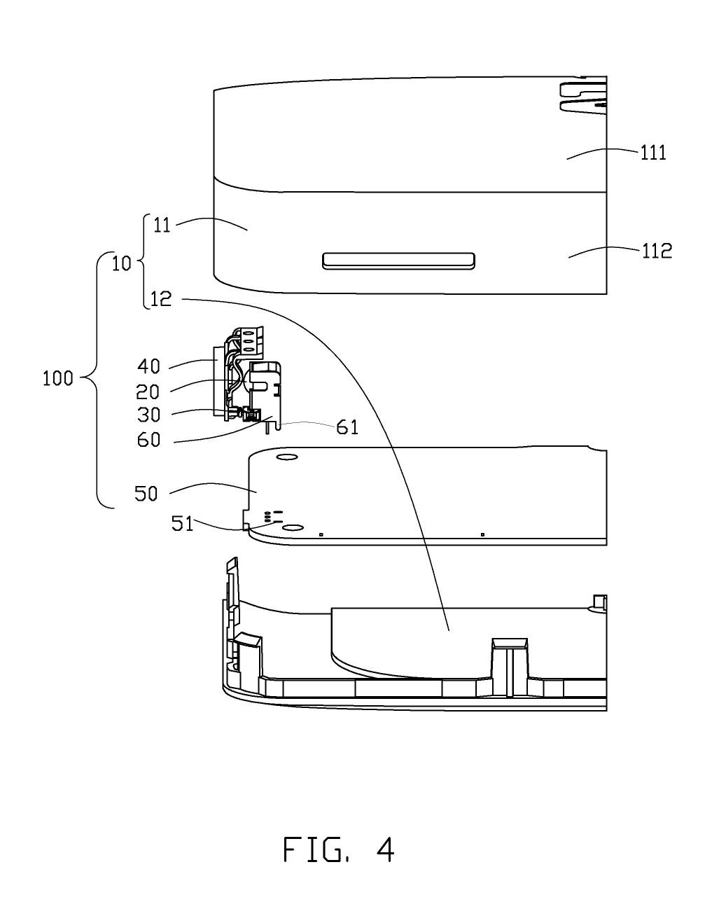

FIG. 4 illustrates the set-top box 100 further includes a infrared signal receiver 20 received in the receiving space 13. The infrared signal receiver 20 is electrically coupled to the mounting block 60. The infrared signal receiver 20 is configured to receive infrared signals. Infrared signals may pass through the pressing block 41 mounted in the mounting hole 1121 and the connecting plate 42 and be received by the infrared signal receiver 20.

The set-top box 100 further includes a power button 30 received in the receiving space 13 and facing the operation button 40. The power button 30 is electrically coupled to the mounting block 60. The power button 30 is configured to power on or power off the set-top box 100.

The set-top box 100 further includes a circuit board 50 received in the receiving space 13. The mounting block 60 is located on and electrically connected with the circuit board 50, thus the infrared signal receiver 20 and power button 30 are electrically coupled to the circuit board 50. The infrared signal receiver 20 can send the infrared signal to the circuit board 50, and the power button 30 can send the power on or power off signal to the circuit board 50.

The in at least one embodiment, a plurality of fixing holes 51 are defined in the circuit board 50. The mounting block 60 includes a plurality of fixing posts 61. Each fixing post 61 is mounted in a fixing hole 51, the mounting block 60 is electrically fixed on the circuit board 50 by the fixing posts 61,

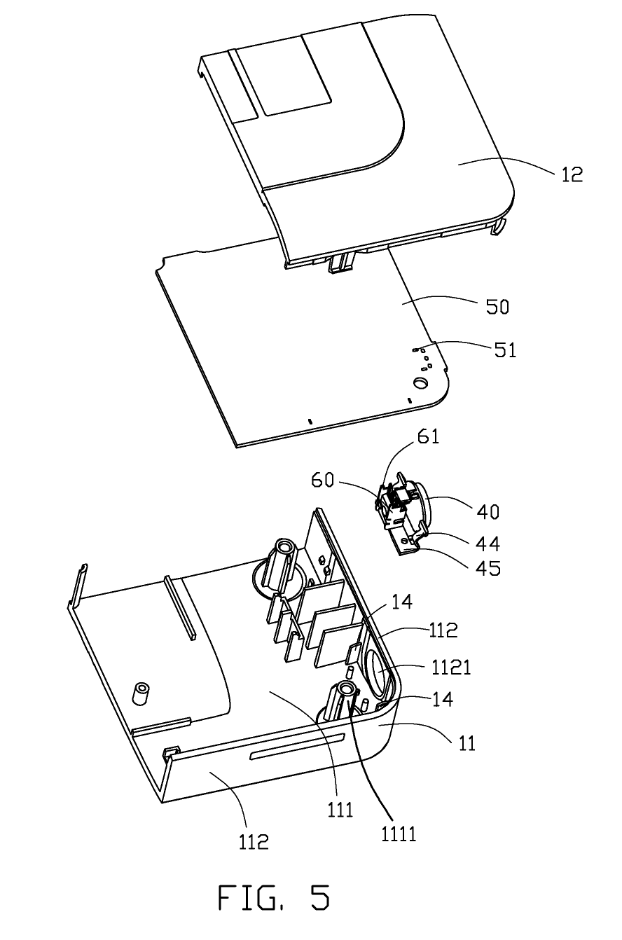

FIG. 5, illustrates in at least one embodiment, two mounting posts 1111 are received in the receiving space 13 and secured to the bottom portion 111. The circuit board 50 is fixed on the mounting post 1111 by fastening elements.

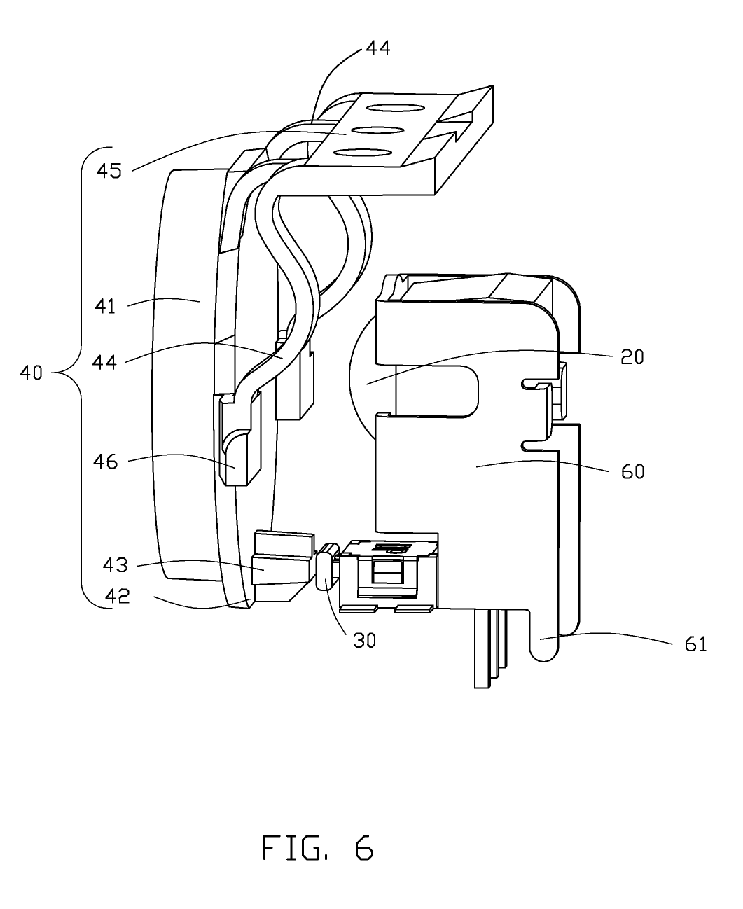

FIG. 6 illustrates the power button 30 faces the protrusion 43. When the operation button 40 is pressed, the protrusion 43 moves with the connecting plate 42 toward the power button 30 and actuates the power button 30, to cause the set-top box 100 to be powered on or powered off

In use, the user can press the operation surface 411 of the pressing block 41, then the connecting plate 42 and the protrusion 43 move with the pressing block 41 toward the power button 30 and infrared signal receiver 20, at the same time, the supporting portion 461 slides along the supporting plate 14, the end of elastic arms 44 secured to the connecting plate 42 moves with the connecting plate 42, to cause the elastic arms 44 to be elastically deformed and store elastic potential energy, then the protrusion 43 touches and presses the power button 30, thus the set-top box 100 is powered on, that means the circuit board 50 is powered on; then the circuit board 50 sends the power on signal to the infrared signal receiver 20, thus the infrared signal receiver 20 is powered on. After the set-top box 100 is powered on, the user can release the operation surface 411, the elastic potential energy stored by the elastic arms 44 reverts to elastic force, the elastic arms 44 rebound to push the connecting plate 42 and the pressing block 41 to move away from the receiving space 13 until the connecting plate 42 contacts the sidewall 112. After the set-top box 100 is turned on, when the remote control machine (not shown) emits an infrared remote control signal toward the mounting hole 1121, the infrared signal passes through the pressing block 41 and connecting plate 42 and is received by the infrared signal receiver 20, the infrared signal receiver 20 sends the signal to the circuit board 50, thus controlling the set-top box 100. To powered off the set-top box 100, the user just needs to press the operation surface 411 of the pressing block 41, and then release the operation surface 411.

It is to be understood, even though information and advantages of the present embodiments have been set forth in the foregoing description, together with details of the structures and functions of the present embodiments, the disclosure is illustrative only; changes may be made in the details, especially in matters of shape, size, and arrangement of parts within the principles of the present embodiments to the full extent indicated by the plain meaning of the terms in which the appended claims are expressed.

What is claimed is:

1. A set-top box comprising:
a casing defining a receiving space and a mounting hole, which is coupled to the receiving space; and
an infrared signal receiver mounted in the receiving space and configured to receive infrared signal; and
an operation button configured to contact a power button, which is slidably received in the mounting hole;
wherein the operation button is made of material allowing the infrared signal to pass through, so that infrared signal enters the set-top box through the operation button and is directed to the infrared signal receiver.

2. The set-top box as claimed in claim 1, wherein the set-top box further comprises a power button received in the receiving space, and configured to power on or power off the set-top box.

3. The set-top box as claimed in claim 2, wherein the casing comprises a bottom cover, and a top cover engaged with the bottom cover, the bottom cover and top cover cooperatively form the receiving space.

4. The set-top box as claimed in claim 3, wherein the bottom cover comprises a bottom portion, and a plurality of sidewalls surrounding the bottom portion, the mounting hole is defined in one of the sidewalls.

5. The set-top box as claimed in claim 4, wherein the operation button comprises a pressing block, and a connecting plate connected to one surface of the pressing block, the pressing block and connecting plate are made of material which admits infrared signals to pass through.

6. The set-top box as claimed in claim 5, wherein the pressing block is slidably received in the mounting hole, and the connecting plate is received in the receiving space, the connecting plate is wider than the pressing block and the mounting hole.

7. The set-top box as claimed in claim 5, wherein the operation button further comprises a protrusion connected to the connecting plate and facing the power button, the protrusion and pressing block are located on two opposite surfaces of the connecting plate.

8. The set-top box as claimed in claim 5, wherein the operation button further comprises at least one elastic arm, one end of the elastic arm is coupled to the connecting plate, and the other end of the elastic arm is coupled to the casing.

9. The set-top box as claimed in claim 8, wherein the set-top box further comprises a fixing plate received in the receiving space, the fixing plate is coupled to the casing, and the elastic arm is coupled to the casing via the fixing plate.

10. The set-top box as claimed in claim 8, wherein the set-top box further comprises two supporting blocks located on two opposite edges of the connecting plate, and two supporting plates located on the bottom cover and adjacent to the mounting hole, each supporting block includes a supporting portion extending from the edge of the supporting block, each supporting portion abuts against the supporting plate.

11. The set-top box as claimed in claim 2, wherein the set-top casing further comprises a circuit board received in the receiving space, the infrared signal receiver and power button are coupled electrically connected to the circuit board.
